(19) United States
(12) Patent Application Publication
(10) Pub. No.: US 2025/0029431 A1
(43) Pub. Date: Jan. 23, 2025

(54) MOBILE BODY AND MANAGEMENT SYSTEM

(71) Applicant: TOYOTA JIDOSHA KABUSHIKI KAISHA, Toyota-shi (JP)

(72) Inventors: Yuko TERASAWA, Tokyo (JP); Tomoyoshi UEKI, Toyota-shi (JP); Masahiro KAGAMI, Nagoya-shi (JP); Yasuhide KURIMOTO, Kasugai-shi (JP); Hiroshi YAMASAKI, Nagoya-shi (JP); Kenji ZAITSU, Nisshin-shi (JP); Yoshihiko ENDO, Tokyo (JP)

(73) Assignee: TOYOTA JIDOSHA KABUSHIKI KAISHA, Toyota-shi (JP)

(21) Appl. No.: 18/734,101

(22) Filed: Jun. 5, 2024

(30) Foreign Application Priority Data
Jul. 19, 2023 (JP) 2023-117556

(51) Int. Cl. G07C 5/00; G07C 5/10; H01M 10/42; H01M 10/48; H04L 9/40

(52) U.S. Cl. CPC G07C 5/008; G07C 5/10; H01M 10/4221; H01M 10/48; H04L 63/08; H01M 2220/20

(57) ABSTRACT

The mobile body includes a power storage device and a control device. The control device stores identification information of a first power storage device when the first power storage device is installed in the mobile body as the power storage device. When the first power storage device is replaced with the second power storage device and the identification information of the first power storage device stored in the control device is rewritten to the identification information of the second power storage device, the control device transmits a first signal indicating that the power storage device is replaced to the outside of the mobile body.

### CROSS-REFERENCE TO RELATED APPLICATION

This application claims priority to Japanese Patent Application No. 2023-117556 filed on Jul. 19, 2023, incorporated herein by reference in its entirety.

### BACKGROUND

### 1. Technical Field

The present disclosure relates to a mobile body and a management system.

### 2. Description of Related Art

Japanese Unexamined Patent Application Publication No. 2017-189032 (JP 2017-189032 A) discloses technology for determining whether first vehicle type information included in a vehicle control unit matches second vehicle type information included in a battery control unit, when an auxiliary battery that supplies electric power to the vehicle control unit and the battery control unit is attached or detached.

### SUMMARY

A electrified vehicle such as a battery electric vehicle, for example, includes a power storage device (e.g., a drive battery) for traveling. In general, a power storage device for traveling is large in capacity and expensive. Such a large-capacity power storage device is not replaced immediately in the event of a failure, and is repaired if it can be repaired. However, when a vehicle manager requests a repair shop to repair a power storage device installed in a vehicle, the repair shop may replace the power storage device, contrary to the intention of the vehicle manager.

The present disclosure has been made in order to solve the above problem, and an object thereof is to notify those outside of the mobile body that the power storage device installed in the mobile body has been replaced.

A mobile body according to an embodiment of the present disclosure includes a power storage device, and a control device. The control device stores identification information of a first power storage device when the first power storage device is installed in the mobile body as the power storage device. The control device is configured to, when the first power storage device is replaced with a second power storage device, and also the identification information of the first power storage device stored in the control device is rewritten to identification information of the second power storage device, transmit a first signal making notification to those outside of the mobile body that the power storage device is replaced.

According to the present disclosure, those outside of the mobile body can be notified that the power storage device installed in the mobile body has been replaced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a management system according to an embodiment of the present disclosure;

FIG. 2 is a diagram showing a configuration of the information platform shown in FIG. 1;

FIG. 3 is a diagram illustrating a configuration of a mobile body according to an embodiment of the present disclosure;

FIG. 4 is a flow chart illustrating a control system according to an embodiment of the present disclosure; and

FIG. 5 is a flowchart illustrating a process related to annunciation control executed by the mobile body according to the embodiment of the present disclosure.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

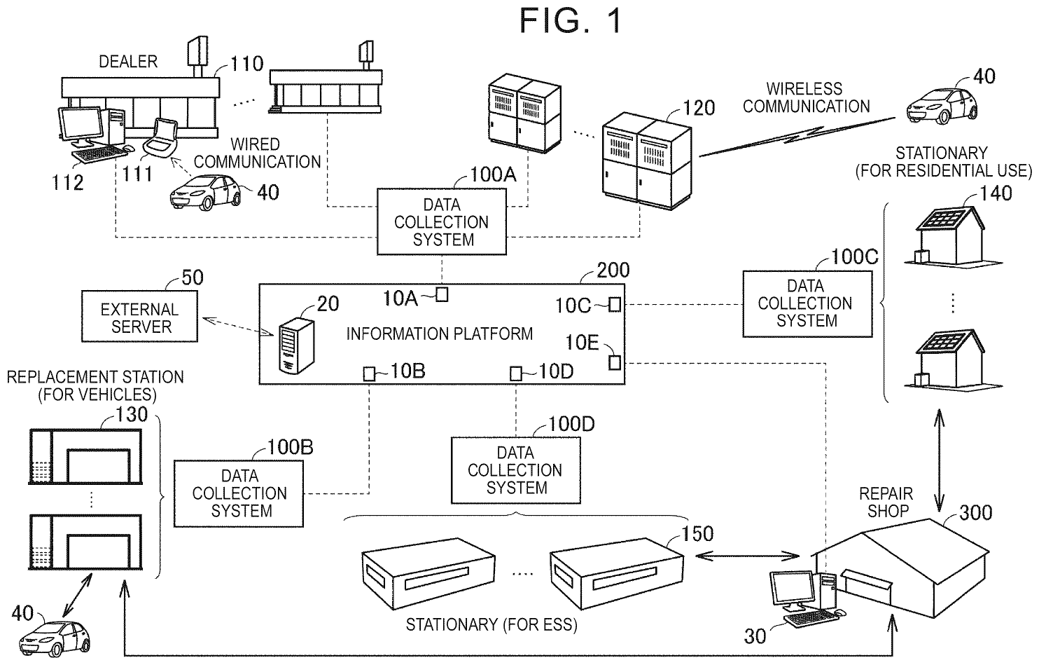

FIG. 1 is a diagram illustrating an outline of a management system according to the embodiment. The management system illustrated in FIG. 1 includes a managing terminal 30, a plurality of vehicles 40, a server 50, a data collection system 100A to 100D, a plurality of dealers 110, a plurality of vehicle managing devices 120, a plurality of replacing stations 130, a plurality of houses 140, a plurality of Energy Storage System (ESS) 150, an information platform 200, and a repair shop 300. In this system, a plurality of power storage devices is circulated. Each power storage device is sequentially used by a plurality of users. For example, a power storage device used by one user may be provided to another user. Each power storage device is provided with unique identification information (hereinafter, referred to as “battery ID”) so that each power storage device circulating in the system can be identified. The owner and the user of the power storage device are registered in the information platform 200, and unique identification information is added thereto. The location where the power storage device is used (the vehicle 40, the house 140, and ESS 150) and the storage location (the replacing station 130 and the repair shop 300) are also registered in the information platform 200, and unique identification information is assigned thereto.

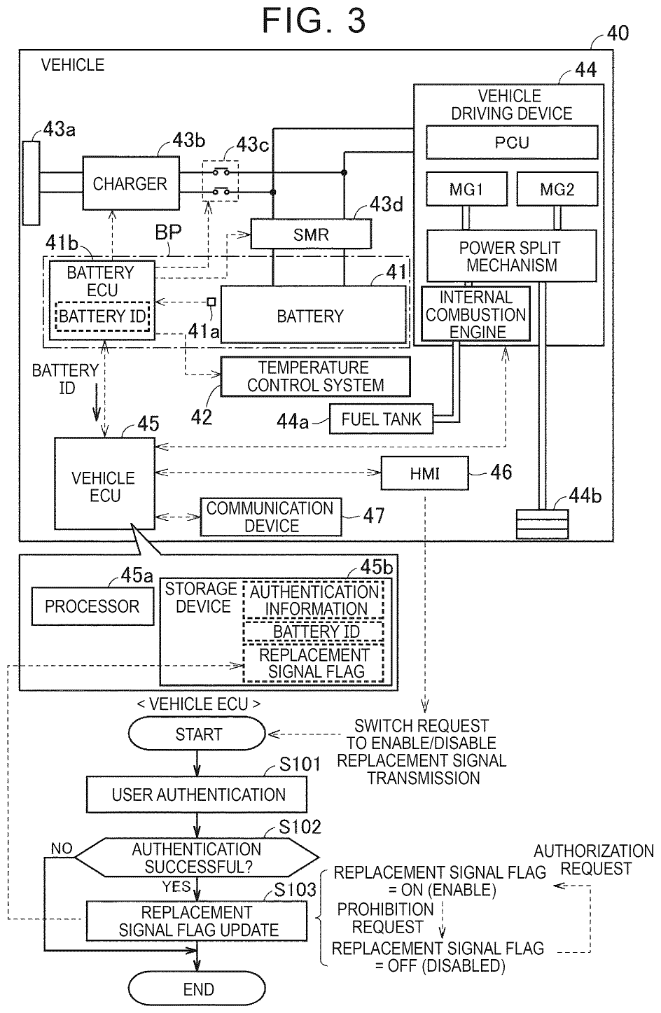

A power storage device is installed in each of the plurality of vehicles 40. The identification information of the respective vehicles (hereinafter, referred to as “vehicle ID”) may be Vehicle Identification Number (VIN). Details of the configuration of the vehicle 40 will be described later (see FIG. 3).

The dealer 110 includes a scanning tool 111 and a dealer terminal 112 (e.g., a computer). The scanning tool 111 acquires information (including vehicle ID and battery ID) from the vehicle 40 that has visited the dealer 110 through wired communication. The information of the vehicle 40 acquired by the scanning tool 111 is transmitted to the dealer terminal 112. The dealer terminal 112 manages information for each vehicle by distinguishing the information by vehicle ID.

The vehicle managing device 120 includes a terminal (for example, a computer) configured to be capable of wirelessly communicating with the vehicle 40 that is traveling or stopped. The vehicle managing device 120 acquires information (including the vehicle ID and the battery ID) from each of the plurality of vehicles 40 by radio communication. The vehicle managing device 120 manages the information of the respective vehicles by distinguishing them by the vehicle ID.

The replacing station 130 is configured to store the replacement power storage device and exchange the power storage device installed in the vehicle 40. Specifically, the replacing station 130 removes the power storage device from the vehicle 40 and attaches another power storage device (replacement power storage device) to the vehicle 40.

The house 140 includes a photovoltaic power generation system and a stationary power storage system (a residential power storage system). The power storage system is configured to be capable of supplying power to the house 140. The power storage system can also store electric power generated by the photovoltaic power generation system.

ESS 150 is a stationary power storage system larger than the residential power storage system. ESS 150 serves as a power source for the power system or facilities. The power system is a power grid constructed by a transmission and distribution facility. Examples of facilities include factories and commercial facilities. ESS 150 may also store excess power.

The repair shop 300 is configured to repair a power storage device. The failed power storage device is sent to the repair shop 300 and repaired in the repair shop 300. When the power storage device installed in the vehicle 40 fails, the manager (user) of the vehicle 40 deposits the vehicle 40 to the repair shop 300. In the repair shop 300, the power storage device is repaired while the power storage device is attached to the vehicle 40. The repair shop 300 is configured to be capable of storing a plurality of power storage devices and also functions as a warehouse. The managing terminal 30 is installed in the repair shop 300 and manages information (inventory information) of each power storage device stored in the repair shop 300.

Each of the vehicles 40, the replacing station 130, the house 140, ESS 150, and the repair shop 300 comprises a Battery Management System (BMS). BMS includes a detector for detecting the status of the power storage device, and a controller for recording the detection result of the detector in the storage device in association with the detection time. However, BMS of the storage location may be omitted.

The data collection system 100A is configured to, for example, periodically collect information on the in-vehicle power storage device from each of the plurality of dealers 110 (dealer terminals 112) and the plurality of vehicle managing devices 120, and to database the collected information. The information of the power storage device of each vehicle acquired by BMS of each vehicle is transmitted to the scanning tool 111 or the vehicle managing device 120 by wired communication or wireless communication, respectively.

The data collection 100B, 100C, 100D is configured to collect information on the replacement power storage device, information on the residential power storage device, and information on ESS power storage device, and to database the collected information. BMS in each of the replacing station 130, the house 140, and ESS 150 transmit the power storage device information to the corresponding data collection system in response to a request from the corresponding data collection system or periodically.

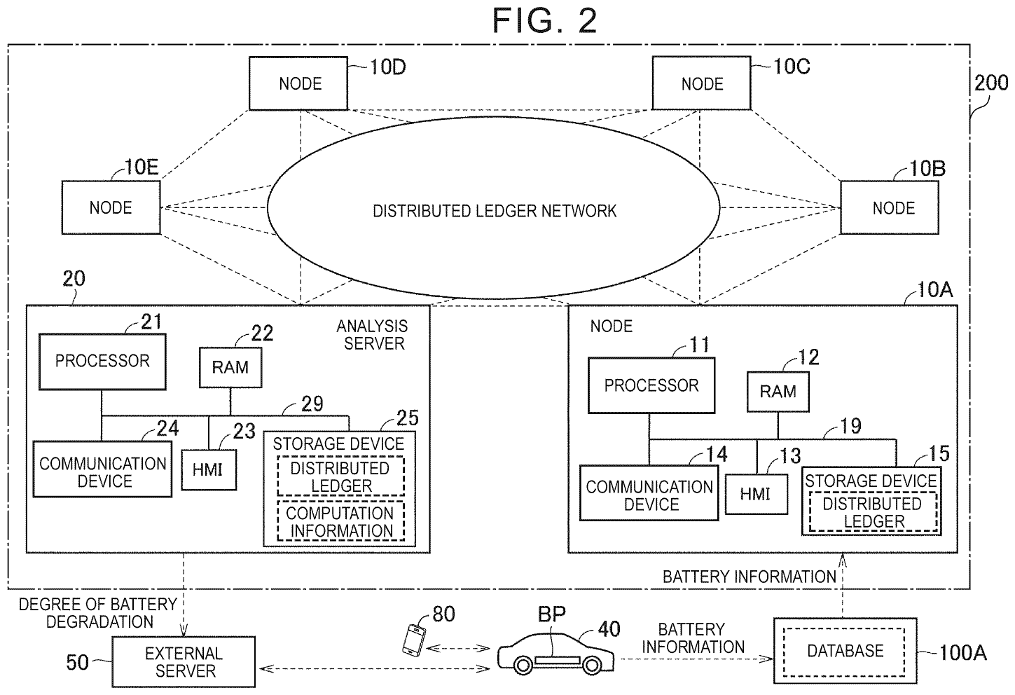

The information platform 200 includes a node 10A, 10B, 10C, 10D, 10E (for example, a computer) corresponding to each of the data collection system 100A, 100B, 100C, 100D and the managing terminal 30. The information platform 200 further comprises a server 20. These nodes and servers 20 form a distributed ledger network (hereinafter referred to as “DLN”). However, the number of nodes can be changed as appropriate. The information platforms 200 manage information of the respective power storage devices distributed in the system by using a distributed ledger technique using, for example, a blockchain (hereinafter, referred to as “BLC”). In the distributed ledger, all the information from the start of the operation of the distributed ledger to the present is recorded. FIG. 2 is a diagram illustrating a configuration of the information platform 200.

Referring to FIG. 2, the node 10A includes a processor 11, a Random Access Memory (RAM) 12, a Human Machine Interface (HMI) 13, a communication device 14, and a storage device 15, which are connected to a bus 19. The storage device 15 stores a distributed ledger. Although only the configuration of the node 10A is illustrated in FIG. 2, basically the same configuration as the node 10A illustrated in FIG. 2 is adopted for the other node 10B to 10E.

The servers 20 also have distributed ledgers and function as DLN nodes. The information recorded in the distributed ledger is shared by all the nodes of DLN. The server 20 also functions as an analysis server that analyzes the information added to the distributed ledger by the node 10A to 10E. The server 20 includes a processor 21, a RAM 22, an HMI 23, a communication device 24, and a storage device 25, which are connected to a bus 29. The storage device 25 stores a distributed ledger. The storage device 25 further stores information (operation information) for information analysis.

In the distributed ledger of each node of DLN, information (hereinafter, referred to as “battery information”) related to each power storage device distributed in the system is recorded. The battery information includes identification information (battery ID) of the power storage device, identification information (owner ID) of the owner of the power storage device, identification information (user ID) of the user using the power storage device, identification information (for example, vehicle ID) of the use location of the power storage device, specification information of the power storage device, and usage history information of the power storage device. However, the battery information is not limited to these pieces of information, and may further include other information related to the power storage device (for example, material composition information, insurance contract information, performance evaluation information, and a control program).

When the data collection system 100A, 100B, 100C, 100D or the managing terminal 30 acquires the new battery information, the corresponding node records the new block including the battery information in the distributed ledger. Specifically, the corresponding node generates transactional data including the battery information, identification information (recorder ID) of the node, and a recording time. Subsequently, the node records a new block including the generated transaction data and the hash value of the past transaction data (previous block) in the distributed ledger. As a result, the distributed ledgers of the respective nodes of DLN are updated. Various kinds of information included in the new block are linked to each other.

The vehicle 40 is configured to be capable of wirelessly communicating with each of the server 50 and the mobile terminal 80. The server 50 according to this embodiment is an external server including a processor and a storage device. The server 50 provides a predetermined service (e.g., an insurance service) using information (e.g., a degree of battery degradation) obtained from the information platform 200. The mobile terminal 80 is a terminal that can be carried by a user of the vehicle 40. In this embodiment, a smartphone including a touch panel display is adopted as the mobile terminal 80. The smartphone has a built-in computer and has a speaker function. However, the present disclosure is not limited thereto, and a wearable device, an electronic key, or the like can be employed as the mobile terminal 80.

The vehicles 40 are, for example, plug-in hybrid electric vehicle (PHEV). Vehicle 40 includes a battery-pack BP. FIG. 3 is a diagram illustrating a configuration of the vehicle 40. Referring to FIG. 3, the battery pack BP includes a battery 41, a detector 41a, and a battery ECU 41b. As the battery 41, a known power storage device for a vehicle (for example, a secondary battery) can be adopted. The detector 41a includes various sensors that detect the status (e.g., temperature, current, and voltage) of the battery 41. The detector 41a may include a strain sensor for detecting a degree of strain of the battery case. The battery ECU 41b is a controller including a processor and a storage device. The storage device of the battery ECU 41b stores the identification information (battery ID) of the battery 41 in advance. In addition, the battery Electronic Control Unit (ECU) 41b sequentially records the detection result by the detector 41a in the storage device in association with the detection time.

The vehicle 40 further includes a temperature control system 42 for adjusting the temperature of the battery 41. The temperature control system 42 includes at least one of a heating device and a cooling device. The temperature control system 42 may adjust the temperature of the battery 41 by circulating a heat medium (for example, water, an antifreeze liquid, or a gas) that exchanges heat with the battery 41. The temperature control system 42 is controlled by, for example, a battery ECU 41b.

The vehicle 40 further includes an inlet 43a, a charger 43b, a charging relay 43c, a System Main Relay (SMR) 43d, a vehicle drive device 44, a fuel-tank 44a, a drive-wheel 44b, a vehicle ECU 45, an HMI 46, and a communication device 47. The inlet 43a, the charger 43b, the charging relay 43c, and SMR 43d are disposed on a charging line that guides electric power from the outside of the vehicle to the battery 41. In addition, SMR 43d switches connection/disconnection of an electric path connecting the vehicle drive device 44 and the battery 41. Each of the charger 43b, the charging relay 43c, and SMR 43d is controlled by, for example, a battery ECU 41b. The vehicle ECU 45 includes a processor 45a and a storage device 45b. The vehicle ECU 45 exchanges information with each of the battery ECU 41b, HMI 46 and the communication device 47. The vehicle ECU 45 stores the battery ID received from the battery ECU 41b in the storage device 45b. In addition, the storage device 45b stores authentication information for user authentication in advance. HMI 46 includes an inputting device and a displaying device. HMI 46 may include a touch panel display. The communication device 47 communicates with the outside of the vehicle. The communication device 47 includes a wireless communication device.

The vehicle drive device 44 is, for example, a series-parallel hybrid drive device. The vehicle drive device 44 includes a plurality of Motor Generator (MG), Power Control Unit (PCU), a power split mechanism, and an internal combustion engine. PCU includes power converting circuits (for example, inverters) and functions as driving circuits for the respective MG. The battery 41 is electrically connected to the respective MG via a PCU. The plurality of MG includes, for example, MG1 for starting and generating power, and MG2 for driving and regenerative braking. Internal combustion engines use fuel (e.g., gasoline, gas oil, or hydrogen) supplied from a fuel reservoir 44a to produce torques. MG2 uses the electric power supplied from the battery 41 to generate torques. MG1 is configured to be capable of generating electric power by using the torque outputted from the internal combustion engine or MG2. The power split mechanisms include planetary gears and are connected to each of MG1, MG2, the internal combustion engine, and the drive wheel 44b. Torque generated by the internal combustion engine or MG2 is transmitted to the drive wheel 44b via a power split mechanism. Although only one drive wheel 44b is shown in FIG. 3, the number of drive wheels is optional. The drive system may be any of front wheel drive, rear wheel drive, and four wheel drive. Vehicle drive device 44 (PCU, internal combustion engines, etc.) are controlled by a vehicle ECU 45. The vehicle ECU 45 functions as an engine ECU for controlling the internal combustion engine.

The configuration of the vehicle drive device 44 is not limited to the above, and can be changed as appropriate. The number of MG is not limited to two, and may be any one. The vehicle drive device 44 may be a series hybrid driving device. The internal combustion engine may be dedicated to power generation. Vehicle 40 may be BEV (battery electric vehicle) or range extender EV.

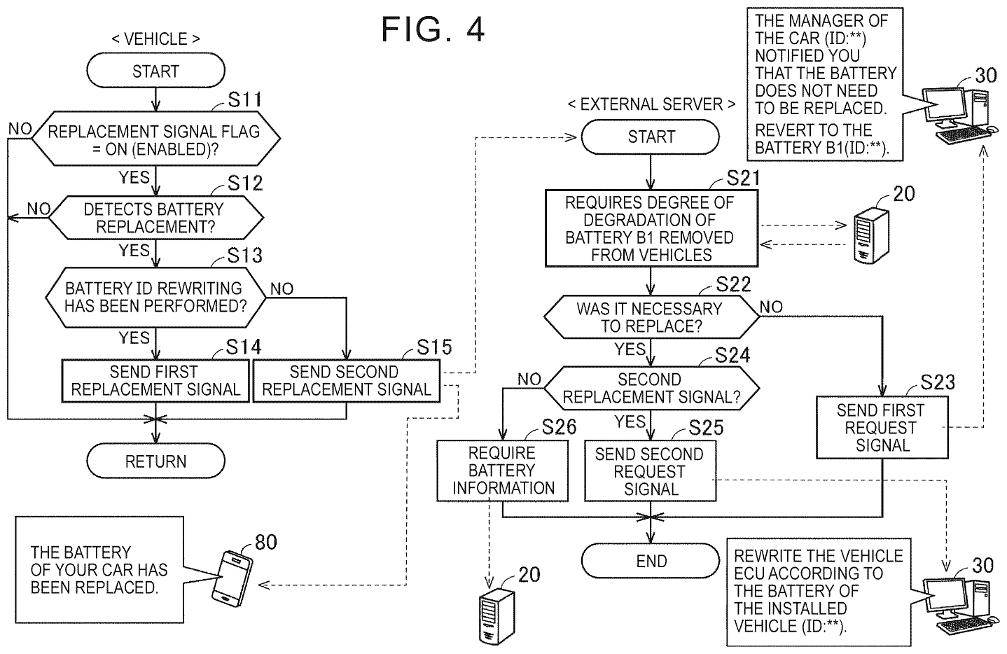

A user of the vehicle 40 can enter instructions or requests to the vehicle ECU 45 through HMI 46. The storage device 45b stores the replacement-signal flag in advance. The replacement signal flag is a parameter indicating whether transmission of a replacement signal (FIG. 4) to be described later is permitted. When the replacement signal flag is ON, it means that the transmission of the replacement signal is permitted. When the replacement signal flag is OFF, it means that the transmission of the replacement signal is prohibited. HMI 46 receives an input (permission request) for requesting that transmission of the replacement signal be permitted and an input (prohibition request) for requesting that transmission of the replacement signal be prohibited. When HMI 46 receives the permission request or the prohibition request, the process illustrated in FIG. 3 is started. Hereinafter, each step in the flowchart is simply referred to as “S”. The process of S101 to S103 is executed by a vehicle ECU 45 (control device).

In S101, the vehicle ECU 45 requests authentication information regarding user authentication from a manager (user) of the vehicle 40. The vehicle ECU 45 may require the mobile terminal 80. In response to this request, the user may input authentication information to the mobile terminal 80. In the following S102, the vehicle ECU 45 compares the authentication information received from the user (the mobile terminal 80) with the authentication information registered in the storage device 45b in advance to determine whether the user authentication is successful. Exemplary authentication information includes user ID, authentication code, biometric information (e.g., fingerprint or facial information). If the user is successfully authenticated (YES in S102), the vehicle ECU 45 changes the replacement signal flag to ON or OFF in response to an authorization request or a prohibition request from the manager (user) of the vehicle 40 in S103. On the other hand, if the user authentication fails (NO in S102), the process is terminated without changing the replacement signal flag. As described above, the vehicle ECU 45 is configured to perform S101, S102 to authenticate the manager of the vehicle 40 and S103 to switch allow or prohibit the transmission of the replacement signal in response to a request from the manager of the vehicle 40. According to such a configuration, it is possible for the vehicle manager to permit transmission of the replacement signal only in a necessary situation. For example, the vehicle manager may permit transmission of a replacement signal before requesting repair of the power storage device.

Incidentally, for example, an electrified vehicle (xEV) such as a PHEV includes a power storage device for traveling (for example, the battery 41). In general, a power storage device for traveling is large in capacity and expensive. Such a large-capacity power storage device is not replaced immediately in the event of a failure, and is repaired in the case where repair is possible, and is replaced in the case where deterioration progresses so as not to be repairable. However, when a vehicle manager requests a repair shop to repair a power storage device installed in a vehicle, the repair shop may replace the power storage device, contrary to the intention of the vehicle manager.

Therefore, in this embodiment, the user of the vehicle 40 deposits the vehicle 40 with the replacement-signal flag turned ON at the repair shop 300. Then, the user of the vehicle 40 requests the repair shop 300 to repair the battery 41. In the repair shop 300, the vehicle 40 repeatedly executes the processing flow illustrated in FIG. 4 described below. When the power of the vehicle system is turned off, the process flow illustrated in FIG. 4 may be started when the vehicle system is restarted. Hereinafter, the battery pack BP and the battery 41 included in the vehicle 40 at the time when the vehicle 40 is deposited in the repair shop 300 will be referred to as “battery pack BP1” and “battery B1”, respectively.

FIG. 4 is a flowchart illustrating a process according to the management method according to the embodiment. The process of S11 to S15 is executed by a vehicle ECU 45 (control device).

Referring to FIG. 4, in S11, the vehicle ECU 45 determines whether the replacement signal flag in the storage device 45b is ON. If the replacement signal flag is ON (YES in S11), the vehicle ECU 45 determines in S12 whether the battery-pack BP1 (including the battery B1) has been replaced. The vehicle ECU 45 may determine whether the battery-pack BP1 has been replaced based on a communication status with the battery ECU 41b (e.g., interruption and resumption). Alternatively, the vehicle ECU 45 may determine whether or not the battery-pack BP1 has been replaced based on information from the battery ECU 41b (e.g., detection by the detector 41a).

When the vehicle ECU 45 detects the replacement of the battery pack BP1 (YES in S12), the vehicle ECU 45 determines, in S13, whether or not the rewriting of the battery ID has been executed together with the replacement of the battery. Hereinafter, the battery pack BP1 by replacing the battery pack, the battery pack BP attached to the vehicles 40 instead of the battery B1, and the battery 41 will be referred to as “battery pack BP2” and “battery B2”, respectively. The battery B1, B2 corresponds to the “first power storage device” and the “second power storage device”, respectively.

In general, Subscriber Identify Module (SIM) information stored in the vehicle ECU 45 (storage device 45b) is rewritten in response to replacement of the battery. Hereinafter, such rewriting of SIM information is also referred to as “ECU rewriting”. SIM information includes a battery ID. Specifically, when the battery pack BP1 is replaced with the battery pack BP2, the battery ECU 41b of the battery pack BP2 transmits the identification information of the battery B2 to the vehicle ECU 45, and the identification information of the battery B1 stored in the storage device 45b is rewritten into the identification information of the battery B2. However, ECU rewriting is not always successful, and ECU rewriting may fail for some reason. In S13, the vehicle ECU 45 determines whether or not ECU rewriting is successful.

When the battery ID stored in the storage device 45b is rewritten into the identification information of the battery B2 (YES in S13), the vehicle ECU 45 transmits the first replacement signal to each of the server 50 and the mobile terminal 80 in S14. The first replacement signal includes the identification information of the vehicle 40, the identification information of the battery B1, and the identification information of the battery B2. When the battery ID stored in the storage device 45b is not rewritten to the identification information of the battery B2 (NO in S13), the vehicle ECU 45 transmits the second replacement signal to each of the servers 50 and the mobile terminals 80 in S15. The second replacement signal includes the identification information of the vehicle 40 and the identification information of the battery B1. Each of the first and second replacement signals is a signal indicating that the power storage device installed in the vehicle 40 has been replaced. The first replacement signal and the second replacement signal correspond to examples of the “first signal” and the “third signal” according to the present disclosure, respectively.

The mobile terminal 80 is carried by a manager (user) of the vehicle 40. Upon receiving the first or second replacement signal, the mobile terminal 80 performs annunciation to the user that the power storage device installed in the vehicle 40 has been replaced. The mobile terminal 80 may display a message indicating that the power storage device has been replaced. By the annunciation, the vehicle manager can know that the power storage device of the vehicle 40 deposited in the repair shop 300 has been replaced contrary to the intention of the vehicle manager.

When the replacement signal flag is OFF (NO in S11), the processes after S12 are not executed. Here, even if the battery B1 is replaced with another battery, the vehicles 40 do not transmit the replacement signals (the first and second replacement signals). The vehicle user can freely perform the battery replacement by turning OFF the replacement signal flag.

Upon receiving the first or second replacement signal, the server 50 starts a process flow of S21 to S26 described below. In S21, the server 50 requests the server 20 for the degree of degradation of the battery B1. The server 50 transmits the identification information of the vehicles 40 and the identification information of the battery B1 to the server 20. The battery B1 corresponds to a power storage device removed from the vehicles 40 by battery replacement in the repair shop 300. In response to a request (S21) from the server 50, the server 20 estimates the degradation degree of the present battery B1 (corresponding to the degradation degree at the time of replacement) based on the usage history information of the battery B1 recorded in the distributed ledger (database), and transmits the estimated degradation degree to the server 50.

The usage history of the battery B1 includes information indicating a status of the battery B1 (for example, a detection result by the detector 41a) during the use period of the battery B1. The server 20 estimates the degree of degradation of the battery B1. The usage history information may include at least one of current data, voltage data, storage amount data, temperature data, communication data, a case distortion degree, and a deterioration degree of an accessory. The server 20 may determine the degree of deterioration of the battery B1 based on at least one of the internal resistance of the battery B1, the capacity retention ratio of the battery B1, the physical degree of deterioration (degree of distortion) of the case of the battery B1, the communication level (communication destabilization, communication interruption, and the like) relating to the system for monitoring the battery B1, the degree of deterioration (disconnection, deformation of the bus bar, and the like) of the electric component of the battery B1, and the degree of deterioration (control failure, failure, and the like) of the environmental component of the battery B1. In this embodiment, each of the detector 41a and the battery ECU 41b serves as a system for monitoring the battery B1. A component corresponding to the temperature control system 42 (a temperature control component in the battery pack BP1) functions as an environmental component of the battery B1. The servers 20 may score the deterioration degree for each evaluation item related to the deterioration degree of the battery B1, and treat the sum of the scores for each evaluation item as the deterioration degree (evaluation result) of the battery B1. The evaluation items may be the above-described six items (internal resistance, capacity retention ratio, case, communication level, electrical component, and environmental component), two or more and five or less items selected from the above-described six items, or one item (for example, internal resistance or capacity retention ratio). The method of determining the degree of degradation of the battery B1 is not limited to the above-described method, and any method can be adopted.

In the following S22, the server 50 determines whether or not the battery B1 needs to be replaced by using the degree of degradation of the battery B1 acquired from the server 20. Specifically, the server 50 determines that the battery B1 needs to be replaced when the degree of deterioration of the battery B1 is larger than the predetermined reference value, and determines that the battery B1 does not need to be replaced when the degree of deterioration of the battery B1 is smaller than the predetermined reference value. In a mode in which the deterioration degree of the battery B1 is evaluated in a plurality of items (for example, the above-described six items), the server 50 may determine that the battery B1 needs to be replaced when the deterioration degree of the battery B1 exceeds a predetermined reference value even in one item. By using the degree of degradation of the battery B1 as described above, the servers 50 can easily appropriately determine whether or not the power storage device needs to be replaced.

When it is determined that the replacement of the battery B1 is not necessary (NO in S22), the server 50 transmits the first requesting signal to the managing terminal 30 in S23. The first request signal is a signal requesting that the battery B2 installed in the vehicle 40 be returned to the battery B1. The first request-signal includes the identification information of the vehicle 40 and the identification information of the battery B1. Upon receiving the first request signal, the managing terminal 30 displays the identification information of the vehicle 40 and the identification information of the battery B1 as shown in FIG. 4, for example, and displays a message prompting the power storage device of the vehicle 40 to return to the battery B1. Such control can prompt the repairer to return the power storage device of the vehicle 40 to the original state when the unnecessary power storage device is replaced. The first request signal corresponds to an example of a “second signal” according to the present disclosure.

When it is determined that the battery B1 needs to be replaced (YES in S22), the server 50 determines whether or not the second replacement signal (S15) has been received from the vehicle 40 in S24. When the server 50 receives the second replacement signal (YES in S24), the server 50 transmits the second requesting signal to the managing terminal 30 in S25. The second request signal is a signal for requesting rewriting of the battery ID (identification information of the power storage device) stored in the vehicle ECU 45. The second request signal includes the identification information of the vehicle 40 and the identification information of the battery B1. Upon receiving the second request signal, for example, as shown in FIG. 4, the managing terminal 30 displays the identification information of the vehicle 40 and displays a message prompting the user to rewrite the battery ID in accordance with the power storage device (battery B2) attached to the vehicle 40. According to this control, when the identification information of the power storage device is not rewritten in spite of the replacement of the necessary power storage device, it is possible to request the repairer to rewrite the identification information of the power storage device. The repairer may perform ECU rewriting using a scanning tool. The control device (vehicle ECU 45) of the vehicle 40 can easily recognize the power storage device installed in the vehicle 40 correctly based on the identification information of the power storage device. The second request signal corresponds to an example of a “fourth signal” according to the present disclosure.

On the other hand, when the server 50 receives the first replacement signal (NO in S24), the server 50 requests the server 20 for information on the power storage device (battery B2) attached to the vehicles 40 in S26. The server 50 transmits the identification information of the vehicles 40 and the identification information of the battery B2 to the server 20. In response to a request from the server 50, the server 20 transmits information related to the battery B2 (for example, specification information of the battery B2 and a control program suitable for the battery B2) to the server 50. Then, the server 50 transmits the information acquired from the server 20 to the vehicle 40.

When any one of S23, S25, S26 processes is executed, S21 to S26 process flow ends. If the repair company returns the battery B2 to the battery B1 in response to S23's request, it may be determined that the battery is YES in S12, and the replacement signal (the first or second replacement signal) may be transmitted from the vehicle 40 to the server 50. Upon receiving the replacement signal, the server 50 may initiate a S21 to S26 process flow. However, in S22, it is determined that the battery needs to be replaced. S21 may be skipped. In S25, it is required to perform ECU rewriting in accordance with the battery B1. In addition, S26 is required information about the battery B1.

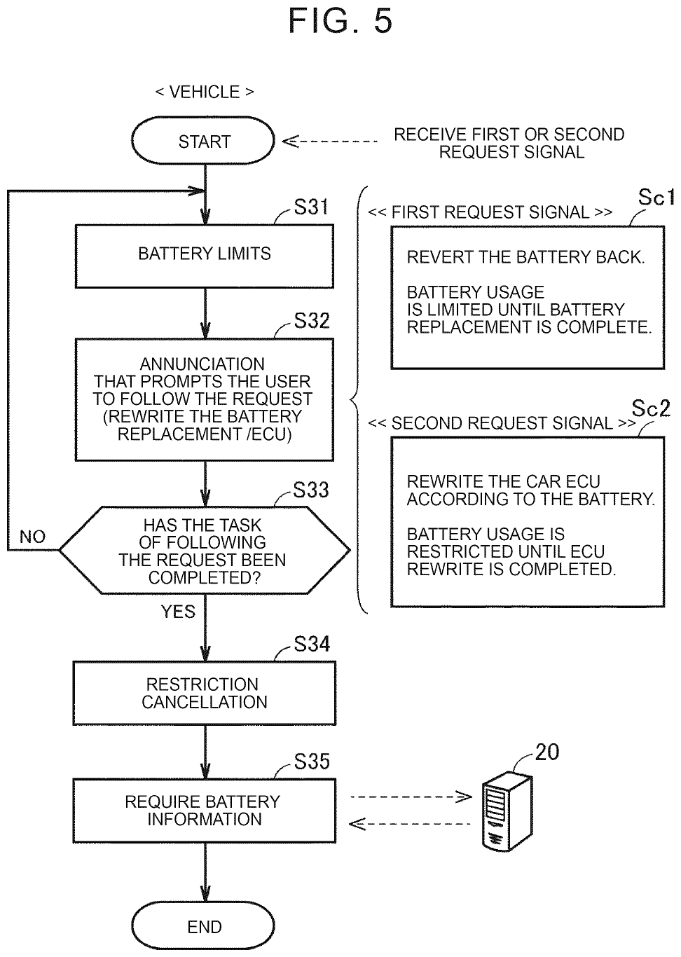

In S23, S25, the servers 50 may transmit the first request signal and the second request signal to the vehicles 40 in place of or in addition to the managing terminal 30. For example, when the vehicle 40 receives the first request signal or the second request signal in the repair shop 300, the vehicle ECU 45 may begin the process flow of S31 to S35 illustrated in FIG. 5 described below. FIG. 5 is a flowchart illustrating a process related to annunciation control executed by the vehicle 40.

Referring to FIG. 5, in S31, the vehicle ECU 45 limits the use of the battery 41. For example, the vehicle ECU 45 sets the power limit of the battery 41 to the battery ECU 41b. As a result, the power of the battery ECU 41b is limited. When the discharging power of the battery 41 exceeds a predetermined value (hereinafter, referred to as “limit value U”), the battery ECU 41b in the output limit state instructs the vehicle ECU 45 to decrease the output of the battery 41. The limit value U is set to, for example, an extent to which electric travel other than slow travel is prohibited. However, the restriction control is not limited to the above-described aspect. For example, SMR 43d may be maintained in a shut-off condition while the use of the battery 41 is restricted.

In a subsequent S32, the vehicle ECU 45 causes HMI 46 to perform an annunciation process that prompts a task according to the first or second request-signal. When the vehicle 40 receives the first request-signal, HMI 46 displays a display Sc1, for example. The display Sc1 includes a message prompting the battery replacement requested by the first request signal. When the vehicle 40 receives the second request signal, HMI 46 displays, for example, a display Sc2. The display Sc2 includes a message prompting ECU rewriting requested by the second request signal.

In the following S33, the vehicle ECU 45 determines whether the operation according to the first or second requested signal received by the vehicle 40 has been completed. While the operation is not completed (NO at S33), S31 to S33 is repeated. On the other hand, when it is determined that the operation has been completed (YES in S33), the vehicle ECU 45 releases the use limit of S31 in S34. Subsequently, the vehicle ECU 45 requests, in S35, the servers 20 for information of the power storage device (battery B2) attached to the vehicle 40. The vehicle ECU 45 transmits the identification information of the vehicle 40 and the identification information of the battery B2. In response to a request from the vehicle 40, the servers 20 transmit information on the battery B2 (specification information, control programs, and the like) to the vehicle 40.

As described above, the control device (vehicle ECU 45) of the vehicle 40 according to this embodiment stores the identification information (battery ID) of the first power storage device when the first power storage device is installed in the vehicle 40 as the power storage device of the vehicle 40 (FIG. 3). When the first power storage device is replaced with the second power storage device and the identification information of the first power storage device stored in the control device is rewritten into the identification information of the second power storage device, the control device (vehicle ECU 45) transmits a first replacement signal (first signal) indicating that the power storage device has been replaced to the outside of the vehicle (S14 in FIG. 4). Such a vehicle can notify the outside of the vehicle that the power storage device has been replaced.

The management method according to this embodiment includes the respective processes illustrated in FIGS. 3 to 5. Each process is executed by one or more processors executing programs stored in one or more memories. However, these processes may be executed by dedicated hardware (electronic circuit) instead of software. Instead of the server 50, the server 20 may execute the process of S21 to S26 illustrated in FIG. 4.

The vehicle 40 corresponds to an example of a “mobile body” according to the present disclosure. The mobile body may be a vehicle other than an automobile (a railway vehicle, an agricultural machine, a building machine, a ship, an airplane, an amphibious vehicle, or the like), or an unmanned mobile body (an unmanned guided vehicle, a walking robot, a drone, a robot cleaner, or the like).

The embodiments disclosed herein should be considered to be exemplary and not restrictive in all respects. The scope of the present disclosure is shown by the scope of claims rather than the description of the above embodiment, and is intended to include all modifications within the meaning and the scope equivalent to the scope of claims.

What is claimed is:

1. A mobile body, comprising:
a power storage device; and
a control device, wherein
the control device stores identification information of a first power storage device when the first power storage device is installed in the mobile body as the power storage device, and
the control device is configured to, when the first power storage device is replaced with a second power storage device, and also the identification information of the first power storage device stored in the control device is rewritten to identification information of the second power storage device, transmit a first signal making notification to those outside of the mobile body that the power storage device is replaced.

2. The mobile body according to claim 1, wherein the control device is configured to execute
authenticating a manager of the mobile body, and
switching between permission and prohibition of transmission of the first signal in response to a request from the manager.

3. A management system, comprising:
the mobile body according to claim 1; and
a mobile terminal, wherein when receiving the first signal, the mobile terminal makes annunciation that the power storage device is replaced.

4. The management system according to claim 3, further comprising:
a database that stores usage history information of the power storage device acquired from the mobile body; and
a server, wherein the server is configured to, when receiving the first signal, execute
acquiring a degree of deterioration of the first power storage device, estimated based on the usage history information,
determining whether replacement of the first power storage device was necessary, using the degree of deterioration, and
when determining that replacement of the first power storage device was unnecessary, transmitting a second signal requesting reverting the second power storage device installed in the mobile body to the first power storage device.

5. The management system according to claim 4, wherein
the control device is configured to, when the first power storage device is replaced with the second power storage device, and also the identification information of the first power storage device stored in the control device is not rewritten to the identification information of the second power storage device, transmit a third signal indicating that the power storage device is replaced, and
the server is configured to, when receiving the third signal, execute
acquiring a degree of deterioration of the first power storage device, estimated based on the usage history information,
determining whether replacement of the first power storage device was necessary, using the degree of deterioration, and
when determining that replacement of the first power storage device was necessary, transmitting a fourth signal requesting rewriting of the identification information of the power storage device that the control device stores.
